(19) United States
(12) Patent Application Publication
(10) Pub. No.: US 2008/0151888 A1
(43) Pub. Date: Jun. 26, 2008

(54) METHOD AND SYSTEM FOR RETRIEVING BROADCAST MEDIA CONTENT THROUGH A COMMUNICATION NETWORK

(75) Inventor: Mohammed M. Ahmed, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,324

(22) Filed: Dec. 20, 2006

(51) Int. Cl. H04L 12/56

(52) U.S. Cl. 370/390; 370/401

(57) ABSTRACT

A method and system for retrieving broadcast media content through a communication network 100 is provided. The method includes the broadcast media content being identified (304) by a first identifier. The method also includes the broadcast media content being identified (306) by a second identifier. Further, the method includes sending (308) the first identifier and the second identifier to a server (104). Moreover, the method includes receiving (310) the broadcast media content.

The present invention generally relates to broadcast media, and more specifically, to a method and system for retrieving broadcast media content through a communication network.

### BACKGROUND OF THE INVENTION

Various forms of broadcast media content, such as audio and/or video, can be broadcasted over a traditional broadcast network. The traditional broadcast network can be a wireless network such as a Terrestrial Television (TV) network, an Amplitude Modulation (AM) radio network, a Frequency Modulation (FM) radio network or a satellite radio network. The traditional broadcast network can also be a wired network such as a cable TV network. The broadcast media content can be received on a receiver device, for example, a TV, an AM/FM radio receiver, a Personal Computer (PC), a mobile phone and other similar devices.

With advances being made in broadcasting technology, users now have access to new features that enable them to customize broadcasted media to their needs. In digital broadcast technology such as Interactive TV, users can alter their viewing experience; get additional information about the broadcasted program and purchase media content instantly. Internet Radio Broadcast also allows a user to purchase broadcasted media content while listening to it.

The above-mentioned features are currently not available for broadcast media content that is broadcasted over a traditional broadcast network. For example, users who are listening to a FM radio station may like the broadcasted song so much that they may want to purchase the song instantly or know more details about it but may not be able to access that information. Unfortunately, techniques are not available that enable instant purchases of media over the traditional broadcast networks.

In light of the foregoing discussion, there is a need for a method and system that will allow the user to retrieve broadcast media content broadcasted over a traditional broadcast network using a communications network.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication network, in accordance with various embodiments of the present invention;

FIG. 2 illustrates an exemplary communication network, in accordance with another embodiment of the present invention;

FIG. 3 is a flow chart illustrating a method for retrieving broadcast media content through a communication network, in accordance with various embodiments of the present invention;

FIG. 4 is a flow diagram illustrating a method for retrieving broadcast media content through a communication network, in accordance with an embodiment of the present invention;

FIG. 5 illustrates a block diagram of a communication device for retrieving broadcast media content through a communication network, in accordance with various embodiments of the present invention; and

FIG. 6 illustrates a block diagram of a server for retrieving broadcast media content through a communication network, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for retrieving broadcast media content through a communication network in accordance with various embodiments of the present invention, it should be observed that the present invention resides primarily in combinations of method steps related to retrieving broadcast media content through a communication network. Accordingly, the apparatus components and method steps have been represented, where appropriate, by conventional symbols in the drawings showing only those specific details that are pertinent for an understanding of the present invention so as not to obscure the disclosure with details that will be readily apparent to those with ordinary skill in the art having the benefit of the description herein.

In this document, the terms “comprises,” “comprising,” or any other variation thereof, are intended to cover a non-exclusive inclusion, such that a process, method, article or apparatus that comprises a list of elements does not include only those elements but can include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising.

For an embodiment, a method for retrieving broadcast media content through a communication network is provided. The broadcast media content can be broadcasted over a traditional broadcast network, and may be retrieved over a communication network such as, a wireless communication network. The method for retrieving broadcast media content includes identifying the broadcast media content by a first identifier. Further, the method includes identifying the broadcast media content by a second identifier. Moreover, the method includes sending the first identifier and the second identifier to a server. Finally, the method includes receiving the broadcast media content based on the identifiers.

For another embodiment, a communication device is disclosed. The communication device can retrieve broadcast media content through a communication network. The communication device includes a transceiver for receiving the broadcast media content as well as a processor. The processor is configured to generate a first identifier and a second identifier corresponding to the broadcast media content. The first identifier may include a timestamp of the broadcast media content. The second identifier may include a broadcast identification corresponding to the desired media content. Further, the processor is configured to forward the first identifier and the second identifier to a server that can deliver the broadcast media content to an end user.

For yet another embodiment, a server in a communication network is disclosed. The server includes a memory module and a processor. The memory module is configured to receive and store a first identifier and a second identifier corresponding to the broadcast media content. The first identifier includes a timestamp of the broadcast media content. The second identifier may include a broadcast identification. The processor is configured to determine a unique ID of the broadcast media content by using the first identifier and the second identifier. Further, the processor is configured to deliver the broadcast media content to an end user by using the unique ID of the media content.

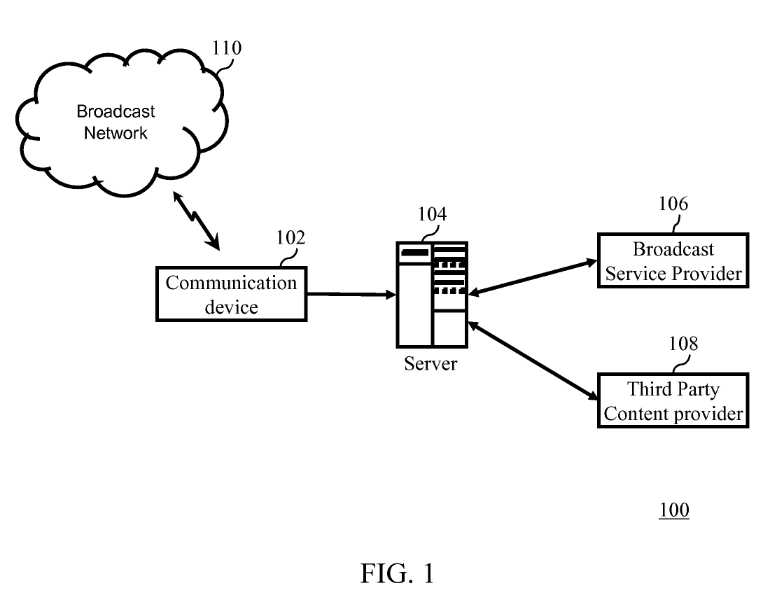

The present invention provides a mechanism to retrieve media content broadcasted over a broadcast network using a communication network. FIG. 1 illustrates an exemplary communication network 100 in accordance with various embodiments of the present invention. The communication network 100 includes a communication device 102, a server 104, a broadcast service provider 106 and a third-party content provider 108.

The communication device 102 can receive media content broadcasted over a broadcast network 110. Examples of the broadcast media content include a song, a movie, a television program or a video clip. The broadcast network 110 may be a conventional broadcast network, including, but not limited to, a terrestrial television broadcast network, an AM/FM radio network, a satellite radio network or a cable TV network. Examples of the communication device can include a mobile phone, Portable Subscriber Unit (PSU), PC, Personal Digital Assistant (PDA), TV, radio and laptop.

As an example, the users may listen to FM radio on their mobile phone. In such a case, they can order the songs by performing a user action like pressing a key on the mobile phone. This user action may generate a first identifier and a second identifier corresponding to the song and provides them to the server 104. The first identifier can be a timestamp, which can be the date and time at which the song was broadcasted. The second identifier can be the broadcast channel identification, such as the frequency of the FM radio channel. Thereafter, the server 104 can provide the first identifier and the second identifier to the broadcast service provider 106, and request for a unique identifier corresponding to the broadcast media content. The broadcast service provider 106 can be a web service hosted by a local radio/TV station or by any other independent entity. The unique identifier can be the information that can uniquely identify the broadcast media content. For example, for a song, the unique identifier can be a combination of fields, such as artist name, album/film name, and the year of release. Once, the unique identifier is obtained, the server 104 can use the unique identifier to order/download the song by communicating with the third-party content provider 108. The third-party content provider 108 can be a web service that sells broadcast media content such as songs, movies, TV programs, etc., online. Examples of the third-party content provider 108 include Amazon.com, iTunes, etc.

For an embodiment, the server 104 and the broadcast service provider 106 can be included in a single device. Therefore, the functions of the server 104 and the broadcast service provider 106 can be executed by a single device with different modules for the server 104 and the broadcast service provider 106.

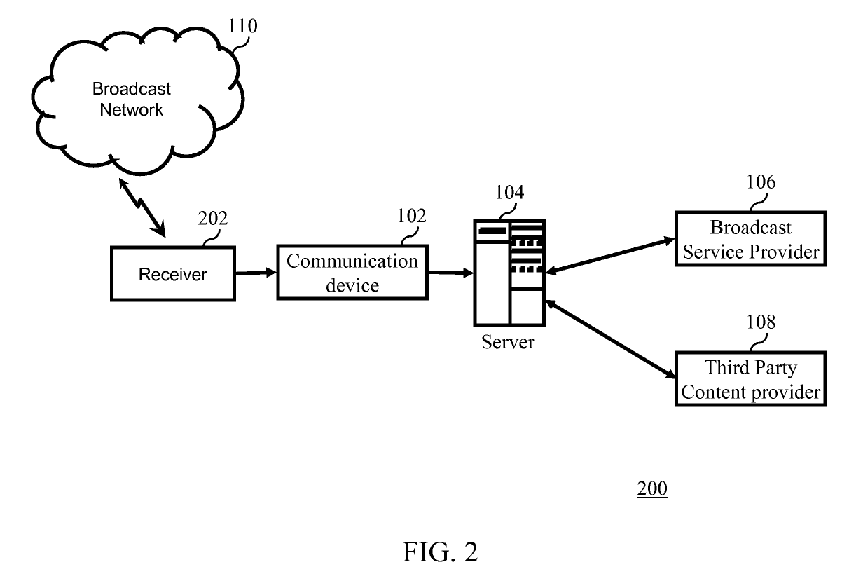

As shown in FIG. 1, the communication device 102 can directly receive signals transmitted by the broadcast network 110. For another embodiment, the communication device 102 may not receive signals transmitted by the broadcast network 110. This embodiment has been explained further in conjunction with FIG. 2.

FIG. 2 illustrates a communication network 200 in accordance with another embodiment of the present invention. The communication network 200 includes the communication device 102, the server 104, the broadcast service provider 106, the third-party content provider 108 and a receiver 202. The receiver 202 can receive the media content broadcasted over the broadcast network 110. For example, the receiver 202 can be a FM radio set, and the communication device 102 can be a mobile phone. The users may receive the broadcast media content, for example, a song, on their FM radio set. The users may show interest in the broadcast media content received at their FM/radio set by pressing a key on their mobile phone.

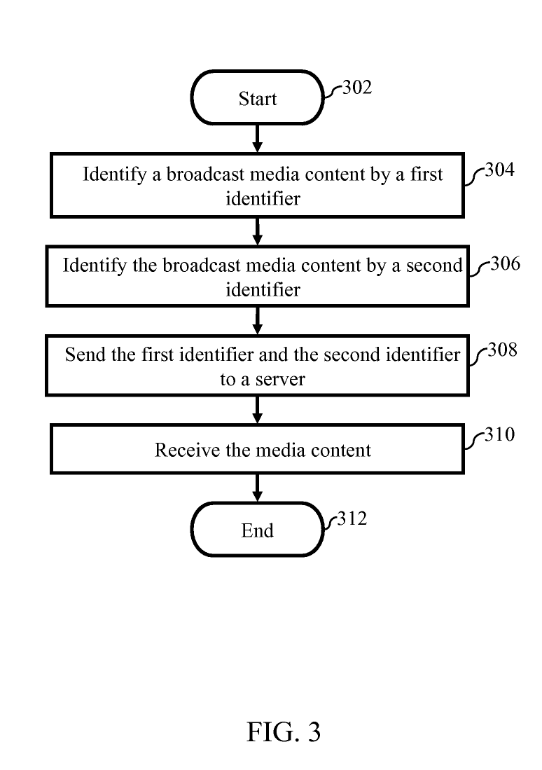

FIG. 3 is a flowchart illustrating a method for retrieving broadcast media content through the communication network 100 in accordance with various embodiments of the present invention. The method for retrieving the broadcast media content starts at step 302. At step 304, the broadcast media content is identified by a first identifier. For an embodiment, the first identifier can include a timestamp of when the broadcast media content was received. The timestamp can indicate the date and time at which the broadcast media content is broadcasted. For example, a user may hear a song at a particular time on a communication device and may want to send a request to retrieve the song. The user may enter the timestamp of the song on the communication device 102. For another embodiment, the user may click a button on the communication device 102 while watching or listening to a program, and, thereby, the timestamp information, i.e. the time of the broadcast, can be automatically recorded in the communication device 102. Further, the timestamp information can be globally synchronized in time, so that the broadcast media content can be uniquely identified by its timestamp together with other identification.

At step 306, the broadcast media content is identified by a second identifier. For an embodiment, the second identifier of the broadcast media content can include a broadcast identification of the broadcast media content. The broadcast identification identifies the media broadcast channel information. For example, a user wants to retrieve a song being played on the 91.1 FM radio channel at 6 pm on Dec. 25, 2006. In such a case, the first identifier can be the timestamp, i.e., 6.00 pm, Dec. 25, 2006, and the second identifier can be the broadcast channel identification, i.e., the 91.1 FM.

For yet another embodiment, one of the first identifier and the second identifier can include a clip of the broadcast media content. For example, the clip of the broadcast media content being received at the communication device 102 can be forwarded to the server 104 along with the timestamp or broadcast channel identification.

At step 308, the first identifier and the second identifier are sent to the server 104. For an embodiment, the communication device 102 sends the first identifier and the second identifier to the server 104. For another embodiment, the first identifier and the second identifier can be sent to the server 104, either instantly or after a time delay. The time delay can be adjusted depending on the user's choice. For example, the users may wish to acquire one or more broadcast media content. Therefore, the users can store one or more first and second identifiers combinations for broadcast media content selections. Further, based on their convenience, the users can send the request after a certain time, for example a week, to acquire the broadcast media content. In another example, the users may want to download a video of the TV serial, which they missed watching the previous day. In such a case, the users can manually enter the timestamp, which can be the date and time of the TV serial, and the TV channel information on the communication device 102.

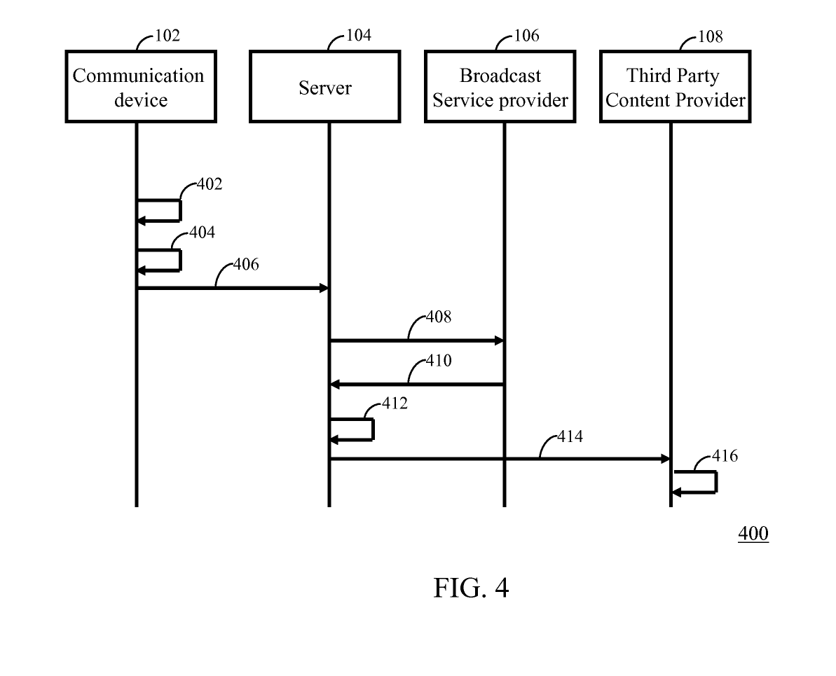

The communication device 102 receives the broadcast media content at step 310 by way of the server 104. One such method for the broadcast media content to be received by the server 104 has been explained further in conjunction with FIG. 4. Thereafter, the method terminates at step 312.

FIG. 4 is a flow diagram 400 illustrating a method for retrieving broadcast media content through the communication network 100, in accordance with an embodiment of the present invention. At step 402, a user performs an action on the communication device 102 while receiving the broadcast media content. Examples of the user action can be pressing a button or key combination on the communication device or a voice signal from the user. For example, a user can hear a song on the communication device 102 and may be interested in downloading the song. So the user can press a key on the communication device 102. The pressing of the key can generate a first identifier corresponding to the song. For an embodiment, the first identifier can be a timestamp of the media content. The timestamp can include the date and time when the user shows interest in the broadcast media content.

At step 404, a second identifier corresponding to the broadcast media content is generated. For an embodiment, the second identifier can be a broadcast-channel identification of the broadcast media content.

For an embodiment, the first identifier and the second identifier corresponding to the broadcast media content can be manually entered by the user. For example, the user can press a key on the communication device 102, whereby a menu appears on the screen of the communication device 102. This prompts the user to enter the broadcast-channel identification and the timestamp of the broadcast media content on the communication device 102.

For another embodiment, one of the first identifier and the second identifier corresponding to the broadcast media content can be entered manually by the user. For example, the user action on the communication device 102 can enable the user to enter the broadcast channel corresponding to the media content, while the timestamp of the broadcast media can be automatically determined by the date and time information present in the communication device 102.

For yet another embodiment, the first identifier and the second identifier can be automatically generated corresponding to the broadcast media content. For example, as a result of the user action on the communication device 102, the timestamp of the broadcast media can be automatically determined by the date and time information present in the communication device 102. In addition, the broadcast channel identification can be automatically set as the current broadcast channel, for example the frequency of the currently tuned FM radio channel.

For still another embodiment, the second identifier can be generated by using a set-top box or a Near Field Communication (NFC) technology-based device. Examples of the NFC technology can include Bluetooth™, ZigBee™, Infrared, and the like. When the broadcast media content is received on the communication device 102, the user can press a key on the communication device 102 or the NFC technology-based device. The pressing of the key generates the second identifier corresponding to the broadcast media content. For example, a user is listening to an FM radio in car. The communication device 102 can be the mobile phone the user is carrying. In addition, the user has a Bluetooth device in the car. In this event, the user can click a button on the Bluetooth device that can communicate with the FM radio to obtain the second identifier, and forward it to the communication device 102.

At step 406, the communication device 102 can send the identifiers corresponding to the timestamp information and the broadcast-channel information to the server 104. At step 408, the server 104 sends a query to the broadcast service provider 106. The query may inquire the broadcast service provider 106 for information about the broadcast media content being played on the broadcast channel specified by the broadcast channel information at the time specified by the timestamp information. For an embodiment, the timestamp of the broadcast media content is globally synchronized in time. This may enable the broadcast service provider 106 to correctly recognize the queries sent by the server 104 at step 408. For an embodiment, the broadcast service provider 106 can maintain a database that includes information about the broadcast media content and their broadcast schedule. For example, the broadcast service provider ‘91.1 FM’ can maintain a database of names of all the songs transmitted on the frequency 91.1 MHz, their broadcast date and time, the album names, the names of the artist, etc. The broadcast service provider 106 can compare the timestamp information received from the server 104 with the broadcast date and time to uniquely determine the song and other corresponding details.

At step 410, the broadcast service provider 106 can send a unique ID of the broadcast media content to the server 104. For example, the unique ID of a song can be information pertaining to the song or the artist, name of the album/film, year of release and the like. The unique ID is determined by the service provider 106 using the first and second identifiers to locate the media content. Further, the unique ID can be a combination of various fields. For example, for a song, the unique ID can be a combination of fields such as the name of singer, name of the album/film, year of release, language, etc.

At step 412, the server 104 can evaluate user preferences that indicate how a user prefers to receive the broadcast media content. For an embodiment, the one or more user preferences include options for providing the broadcast media content by email, download, information update of the broadcast media content or an online update of a play list. For example, the user may wish to upload a song on an online play list. In another example, a user may receive an advertisement of a new product on the communication device 102. The user can get an update of a product by setting the preference to ‘receiving information update’ for the product. In another example, the server 104 can initiate requests for the purchase of the broadcast media content, based on user preferences, when the user preferences are set to ‘download’ or ‘a request for the purchase’ of the broadcast media content. For another embodiment, the user can adjust the preferences to always purchase and download the broadcast media content, for example, a song or a movie. For yet another embodiment the communication device can determine preferences from prior usage patterns of the users. For example, the user may always download the songs that were broadcasted on 91 FM radio channel. In such a case, the user preferences may be set to ‘download songs when second identifier=91 FM radio channel’.

At step 414, the server 104 can send a request to the third-party content provider 108 to purchase the broadcast media content. In response to the request, the third-party content provider 108 can send the broadcast media content requested by the user at step 416. For an embodiment, the third-party content provider 108 can send the broadcast media content to the server 104. Further, the server 104 can send the broadcast media content to the communication device 102. For another embodiment, the third-party content provider 108 can send the content directly to the communication device 102 or to any other location specified by the user.

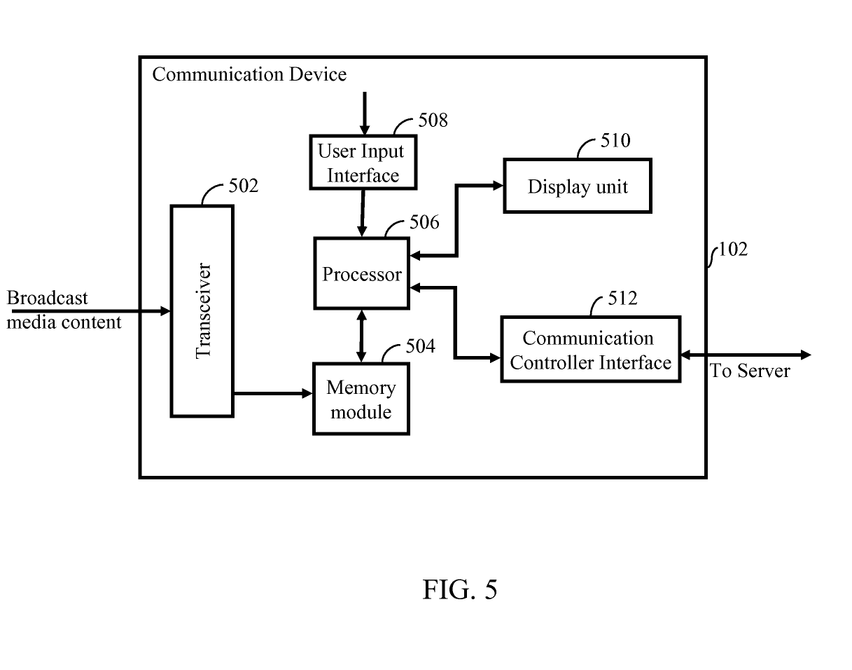

FIG. 5 illustrates a block diagram of the communication device 102, to retrieve broadcast media content through the communication network 100, in accordance with various embodiments of the present invention. Examples of the communication device 102 include, but are not limited to, a PSU, a TV, a radio, a laptop, a PC, and a PDA.

The communication device 102 includes a transceiver 502 for receiving the broadcast media content. Further, the communication device 102 includes a memory module 504, which can receive and store the broadcast media content. Examples of the memory module 504 include, but are not limited to, a dedicated memory, an Electrically Erasable, Programmable, Read-only Memory (EEPROM), an Erasable Programmable Read-only Memory (EPROM), a Flash NAND, a Flash NOR, a Flash Serial, a Non-volatile Random Access Memory (NVRAM), and a Random Access Memory (RAM).

Further, the communication device 102 includes a processor 506. The processor 506 is configured to generate a first identifier and a second identifier corresponding to the broadcast media content, based on a user action. The first identifier and the second identifier can be generated based on a user input. The processor can receive the user input through a user input interface 508. The user input interface 508 can include a key combination a user presses to generate the first identifier and the second identifier corresponding to the broadcast media content. Further, the user input interface 508 can include a mechanism to interpret a voice signal from the user, such that the communication device 102 identifies the user input through the voice signal. For an embodiment, the first identifier includes a timestamp of the broadcast media content, and the second identifier includes a broadcast identification. For another embodiment, the second identifier can include a clip of the broadcast media content. Moreover, the processor 506 can be configured to send the first identifier and the second identifier to the server 104, to deliver the broadcast media content to the user.

For an embodiment, the processor 506 enables the user to enter the first identifier and the second identifier manually. For example, the users may show an interest in receiving the broadcast media content, just by pressing a key on the communication device 102. This user action prompts the user to enter the first identifier and the second identifier on the communication device 102. For another embodiment, the processor 506 enables the communication device 102 to automatically retrieve the first identifier and the second identifier of the broadcast media content. For example, as soon as the user presses a key on the communication device 102, the first identifier and the second identifier corresponding to the broadcast media content are automatically generated by the communication device 102 and are sent to the server 104.

Further, the communication device 102 includes a display unit 510. Examples of the display unit include, but are not limited to, a Cathode Ray Tube (CRT) display, a Vacuum Fluorescent Display (VFD), and a Liquid Crystal Display (LCD). The display unit 510 receives an input from the memory module 504 and the processor 506 and displays the broadcast media content to the users. The display unit 510 can also show the user input, for example, the broadcast channel information entered by the user. Further, the communication device 102 can include a communication controller interface 512 that enables the first identifier and the second identifier being sent to the server 104. The communication controller interface 512 can interact with the server 104 by using any standard wired/wireless communication link.

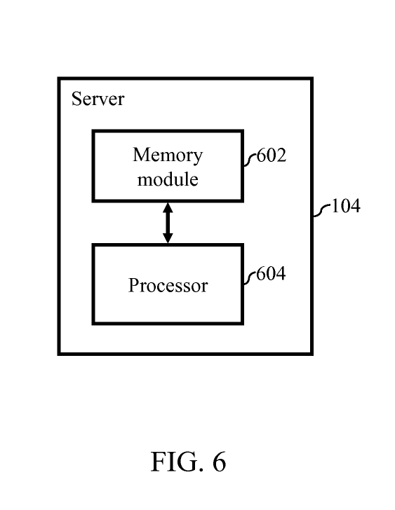

FIG. 6 illustrates a block diagram of the server 104 for retrieving broadcast media content through the communication network 100, in accordance with various embodiments of the present invention. The server 104 includes a memory module 602, and a processor 604. The memory module 602 is configured to receive and store a first identifier and a second identifier of the broadcast media content. The memory module 602 is capable of storing one or more user preferences for the broadcast media content. These one or more user preferences can include options for providing the broadcast media content to the end user. For example, the user can opt to receive the broadcast media content by an email, a download or an information-update of the broadcast media content. Therefore, the end user can be the user communication device or the online play list.

The processor 604 is configured to determine a unique ID of the broadcast media content by using the first identifier and the second identifier. For example, the unique ID of a song can be information pertaining to the song or the artist or a product ID of the song. Further, the processor 604 is configured to deliver the broadcast media content to the end user by using the unique ID derived from the first and second identifiers. Furthermore, the processor 604 is configured to deliver the broadcast media content to the end user, based on the user preferences for the broadcast media content.

As described above, various embodiments of the method and system for retrieving broadcast media content through the communication network provide the following advantages. For an embodiment, the method enables a user to retrieve media content broadcast over a conventional broadcast network. Further, the method enables the users to instantly retrieve the broadcast media content. For another embodiment, the method provides options to the user for receiving the broadcast media content. For example, the user may purchase or download the broadcast media content in real-time while receiving the broadcast media content on the communication device, or make a request for further information on the broadcast media content.

Although the working of present invention has been explained mainly with respect to the example of retrieving a song broadcasted over an FM radio, the scope of the invention can be extended to various other scenarios. For example, while watching news on a TV set, a user can download a news video or receive further updates on the news item on a mobile phone. In another example, the user may receive an advertisement on the TV set and may be interested in receiving details pertaining to the product being advertised. So the user can press a key on the communication device 102 to receive more details of the advertised product.

It should be noted that although the present invention has been explained with reference to broadcast media content broadcasted over traditional broadcast networks, the method disclosed here can be easily extended to any new broadcasting techniques. For example, the present invention can be easily implemented over digital media broadcasting techniques, such as Interactive TV transmission, Internet radio broadcast, streaming audio/video, video on demand, etc.

It will be appreciated that the method and system for retrieving broadcast media content through the communication network, described herein, may comprise one or more conventional processors and unique stored program instructions that control the one or more processors, to implement, in conjunction with certain non-processor circuits, some, most or all of the functions of the system described herein. The non-processor circuits can include, but are not limited to, signal drivers, clock circuits, power-source circuits and user-input devices. As such, these functions may be interpreted as steps of a method to enable control of the one or more devices. Alternatively, some or all the functions could be implemented by a state machine that has no stored program instructions, or in one or more application-specific integrated circuits (ASICs), in which each function or some combinations of certain of the functions are implemented as custom logic. Of course, a combination of the two approaches could also be used. Thus, methods and means for these functions have been described herein.

It is expected that one with ordinary skill, notwithstanding possibly significant effort and many design choices motivated by, for example, the available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of those claims, as issued.

What is claimed is:

1. A method for retrieving a broadcast media content through a communication network, the method comprising:
identifying a broadcast media content by a first identifier;
identifying the broadcast media content by a second identifier;
sending the first identifier and the second identifier to a server; and
receiving the broadcast media content.

2. The method as recited in claim 1, wherein the first identifier comprises a timestamp of the broadcast media content.

3. The method as recited in claim 1, wherein the second identifier comprises a broadcast identification of the broadcast media content.

4. The method as recited in claim 2, wherein the timestamp is globally synchronized in time.

5. The method as recited in claim 1, wherein one of the first identifier and the second identifier comprises a clip of the broadcast media content.

6. The method of claim 1, wherein receiving the broadcast media content comprises acquiring the broadcast media content based on one or more user preferences.

7. The method of claim 1, wherein sending the first identifier and the second identifier further comprising transferring the first identifier and the second identifier to the server after a time delay, further wherein the time delay is based on a user's choice.

8. A communication device capable of retrieving a broadcast media content through a communication network comprising:
a transceiver; and
a processor configured to generate a first identifier and a second identifier corresponding to the broadcast media content, and forward the first identifier and the second identifier to a server for delivering the broadcast media content to an end user, wherein the first identifier comprises a timestamp of the broadcast media content.

9. The communication device of claim 8, wherein the transceiver receives the broadcast media content.

10. The communication device of claim 8, wherein the second identifier comprises a broadcast identification of the broadcast media content.

11. The communication device of claim 8, wherein the processor enables the end user to enter at least one of the first identifier and the second identifier manually.

12. The communication device of claim 8, wherein the processor enables the communication device to retrieve at least one of the one or more identifiers automatically.

13. The communication device of claim 8 further comprising a memory module for receiving a second identifier of the broadcast media content from a Near Field Communication (NFC) Technology device.

14. The communication device of claim 13, wherein the memory module further enables the communication device to receive and store the broadcast media content.

15. A server in a communication network comprising:
a memory module configured to receive and store a first identifier and a second identifier corresponding to a broadcast media content, wherein the first identifier comprises a timestamp of the broadcast media content; and
a processor configured to determine a unique id using the first identifier and the second identifier and deliver the broadcast media content to an end user using the unique id.

16. The server of claim 15, wherein the second identifier further comprises broadcast identification of the broadcast media content.

17. The server of claim 15, wherein the memory module is further capable of storing one or more user preferences for the broadcast media content.

18. The server of claim 17, wherein the one or more user preferences comprises options for providing the broadcast media content by at least one of an email, a purchase request, a download, an information-update of the broadcast media content and an online-update of a play-list.

19. The server of claim 17, wherein the processor is further configured to deliver the broadcast media content to the end user according to the one or more user preferences for the broadcast media content.

20. The server of claim 17, wherein the processor is further configured to initiate a request for ordering the broadcast media content from a third party content provider based on the one or more user preferences.
